(19) United States
(12) Patent Application Publication
(10) Pub. No.: US 2024/0092359 A1
(43) Pub. Date: Mar. 21, 2024

(54) VEHICLE CAMERA-BASED PREDICTION OF CHANGE IN PEDESTRIAN MOTION

(71) Applicant: GM Global Technology Operations LLC, Detroit, MI (US)

(72) Inventors: Oded Bialer, Petach Tikva (IL); Siddhartha Gupta, Rochester Hills, MI (US)

(21) Appl. No.: 17/946,343

(22) Filed: Sep. 16, 2022

(51) Int. Cl. B60W 30/095; B60W 30/09; B60W 60/00; G06T 7/246; G06T 7/277; G06T 7/73; G06V 10/764; G06V 10/82; G06V 20/40; G06V 20/58; G06V 40/10; G06V 40/20; G08G 1/16

(52) U.S. Cl. CPC B60W 30/0956; B60W 30/09; B60W 60/0015; G06T 7/251; G06T 7/277; G06T 7/75; G06V 10/764; G06V 10/82; G06V 20/41; G06V 20/46; G06V 20/58; G06V 40/10; G06V 40/20; G08G 1/166; B60W 2420/42; B60W 2554/4029; G06T 2207/10016; G06T 2207/20084; G06T 2207/30196; G06T 2207/30241; G06T 2207/30261

(57) ABSTRACT

A system in a vehicle includes a camera to obtain video in a field of view over a number of frames and a controller to process the video to identify one or more pedestrians. The controller also implements a neural network to provide a classification of a motion of each pedestrian among a set of classifications of pedestrian motion. Each classification among the set of classifications indicates initiation of the motion or no change in the motion. The controller predicts a trajectory for each pedestrian based on the classification of the motion, and controls operation of the vehicle based on the trajectory predicted for each pedestrian.

### INTRODUCTION

The subject disclosure relates to a vehicle camera-based prediction of a change in pedestrian motion.

Vehicles (e.g., automobiles, trucks, construction equipment, motorcycles) increasingly include sensors that provide information about the vehicle and its environment. While some sensors (e.g., inertial measurement unit, steering angle sensor) provide information about the vehicle itself, other sensors (e.g., radar system, lidar system, camera) provide information about objects (e.g., static objects like trees and signs, pedestrians, other vehicles) around the vehicle. Unlike other vehicles, whose planned motion may be easy to discern based on traffic rules, changes in pedestrian motion may be less predictable. Accordingly, it is desirable to provide a vehicle camera-based prediction of a change in pedestrian motion.

### SUMMARY

In one exemplary embodiment, a system in a vehicle includes a camera to obtain video in a field of view over a number of frames and a controller to process the video to identify one or more pedestrians. The controller also implements a neural network to provide a classification of a motion of each pedestrian among a set of classifications of pedestrian motion. Each classification among the set of classifications indicates initiation of the motion or no change in the motion. The controller predicts a trajectory for each pedestrian based on the classification of the motion, and controls operation of the vehicle based on the trajectory predicted for each pedestrian.

In addition to one or more of the features described herein, the controller identifying the one or more pedestrians includes the controller implementing a second neural network to perform feature extraction on each of the frames of the video to identify features in each of the frames of the video.

In addition to one or more of the features described herein, the controller identifying the one or more pedestrians includes the controller using the features and identification of the one or more pedestrians based on other sensors to identify, as pedestrian features, the features in each of the frames of the video that pertain to the one or more pedestrians.

In addition to one or more of the features described herein, the controller identifying the one or more pedestrians includes the controller performing feature association on the pedestrian features in each of the frames of the video such that all the pedestrian features associated with each pedestrian among the one or more pedestrians are grouped separately.

In addition to one or more of the features described herein, the controller implements the neural network on the pedestrian features associated with each pedestrian to provide the classification of the motion of each pedestrian.

In addition to one or more of the features described herein, the controller predicts the trajectory for each pedestrian using a predictive algorithm.

In addition to one or more of the features described herein, the predictive algorithm uses a Kalman filter and updates a state vector and covariance matrix used by the Kalman filter based on the classification of the motion.

In addition to one or more of the features described herein, the predictive algorithm uses a position and heading for each pedestrian along with a constant velocity model, a constant cartesian acceleration motion model, and an angular acceleration motion model.

In addition to one or more of the features described herein, the controller selects a result of the constant velocity motion model, the constant cartesian acceleration motion model, or the angular acceleration motion model for each pedestrian based on the classification of the motion for the pedestrian.

In addition to one or more of the features described herein, the controller provides two or more classifications of the motion for each pedestrian in conjunction with a probability for each of the two or more classifications of the motion, each of the constant velocity model, the constant cartesian acceleration motion model, and the angular acceleration motion model is associated with one or more of the set of classifications of pedestrian motion, and the controller weights a result of the constant velocity motion model, the constant cartesian acceleration motion model, and the angular acceleration motion model for each pedestrian based on the probability associated with each classification of the motion for the pedestrian.

In another exemplary embodiment, a non-transitory computer-readable medium stores instructions that, when processed by one or more processors, cause the one or more processors to implement a method in a vehicle. The method includes obtaining video from a camera field of view over a number of frames, processing the video to identify one or more pedestrians, and implementing a neural network to provide a classification of a motion of each pedestrian among a set of classifications of pedestrian motion. Each classification among the set of classifications indicates initiation of the motion or no change in the motion. The method also includes predicting a trajectory for each pedestrian based on the classification of the motion and controlling operation of the vehicle based on the trajectory predicted for each pedestrian.

In addition to one or more of the features described herein, the method also includes identifying the one or more pedestrians by implementing a second neural network to perform feature extraction on each of the frames of the video to identify features in each of the frames of the video.

In addition to one or more of the features described herein, the identifying the one or more pedestrians includes using the features and identification of the one or more pedestrians based on other sensors to identify, as pedestrian features, the features in each of the frames of the video that pertain to the one or more pedestrians.

In addition to one or more of the features described herein, the identifying the one or more pedestrians includes performing feature association on the pedestrian features in each of the frames of the video such that all the pedestrian features associated with each pedestrian among the one or more pedestrians are grouped separately.

In addition to one or more of the features described herein, the implementing the neural network on the pedestrian features associated with each pedestrian is performed to provide the classification of the motion of each pedestrian.

In addition to one or more of the features described herein, the predicting the trajectory for each pedestrian includes using a predictive algorithm.

In addition to one or more of the features described herein, the using the predictive algorithm includes uses a Kalman filter and updating a state vector and covariance matrix used by the Kalman filter based on the classification of the motion.

In addition to one or more of the features described herein, the using the predictive algorithm includes using a position and heading for each pedestrian along with a constant velocity model, a constant cartesian acceleration motion model, and an angular acceleration motion model.

In addition to one or more of the features described herein, the method also includes selecting a result of the constant velocity motion model, the constant cartesian acceleration motion model, or the angular acceleration motion model for each pedestrian based on the classification of the motion for the pedestrian.

In addition to one or more of the features described herein, the method also includes providing two or more classifications of the motion for each pedestrian in conjunction with a probability for each of the two or more classifications of the motion, wherein each of the constant velocity model, the constant cartesian acceleration motion model, and the angular acceleration motion model is associated with one or more of the set of classifications of pedestrian motion, and weighting a result of the constant velocity motion model, the constant cartesian acceleration motion model, and the angular acceleration motion model for each pedestrian based on the probability associated with each classification of the motion for the pedestrian.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a vehicle that implements vehicle camera-based prediction of a change in pedestrian motion according to one or more embodiments;

FIG. 2 is a process flow of a method of making a vehicle camera-based prediction of a change in pedestrian motion according to one or more embodiments;

FIG. 3 is a process flow of a method of using a vehicle camera-based prediction of a change in pedestrian motion to control the vehicle according to an exemplary embodiment; and

FIG. 4. is a process flow of a method of using a vehicle camera-based prediction of a change in pedestrian motion to control the vehicle according to an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Embodiments of the systems and methods detailed herein relate to a vehicle camera-based prediction of a change in pedestrian motion. As previously noted, a change in pedestrian motion may be less predictable than the planned motion of another vehicle. The motion of other vehicles on the road may be constrained by lane lines, traffic lights, and the like. Thus, a planned change in motion may be telegraphed or relatively easy to determine (e.g., turn signal, lane change into turn lane, approach of red light or stop sign). On the other hand, a pedestrian walking on a sidewalk may choose to cross the street at any time, for example. A pedestrian walking toward a crosswalk may start to run, as another example.

A camera-based prediction of a pedestrian's trajectory, according to one or more embodiments, may facilitate alerting a driver or performing one or more automated operations of the vehicle (e.g., collision avoidance, automated braking) when a change in motion of the pedestrian may increase the possibility of a collision. As detailed, a neural network may be trained to classify a pedestrian's actions as a motion change event that indicates a planned change in movement of the pedestrian (e.g., start walking, turn right, turn left, stop, walk to run, run to walk). Based on the indication of a motion change event, a pedestrian trajectory prediction may be modified.

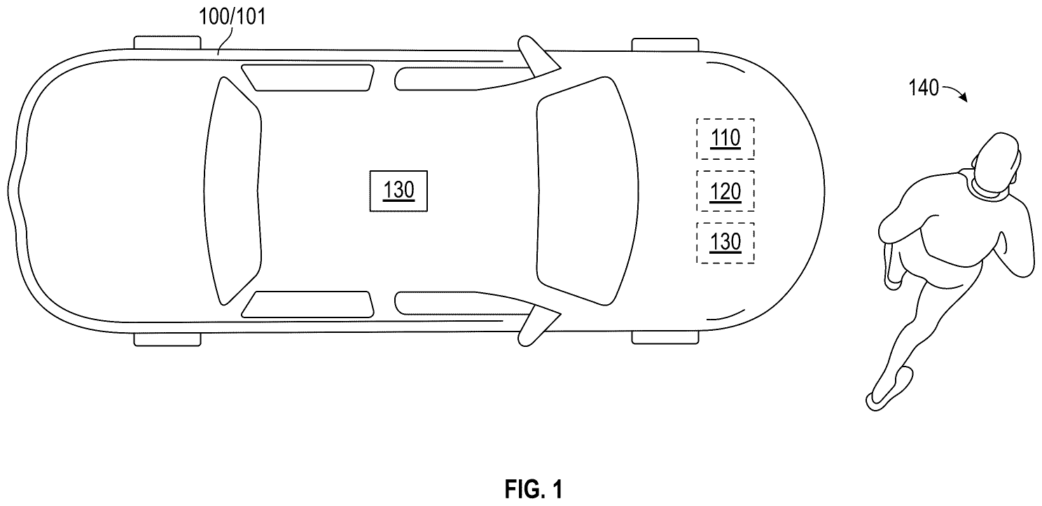

In accordance with an exemplary embodiment, FIG. 1 is a block diagram of a vehicle 100 that implements vehicle camera-based prediction of a change in pedestrian motion. The exemplary vehicle 100 shown in FIG. 1 is an automobile 101. The vehicle 100 is shown to include a camera 110 and other sensors 130 (e.g., radar system, lidar system). The number and location of cameras 110 and other sensors 130 is not intended to be limited by the exemplary illustration in FIG. 1. One or more cameras 110 and other sensors 130 may obtain data about objects around the vehicle 100 such as the pedestrian 140 shown in FIG. 1. In the case of the exemplary camera 110, video images may be obtained.

The vehicle 100 also includes a controller 120. The controller 120 may control various aspects of operation of the vehicle 100. The operational control may be based on information from one or more cameras 110 and other sensors 130. According to one or more embodiments, the controller 120 may use information from the camera 110 to predict a change in pedestrian motion. The controller 120 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The memory of the controller 120 may include a computer-readable medium that stores instructions that, when processed by one or more processors of the controller 120, implement the processes detailed herein.

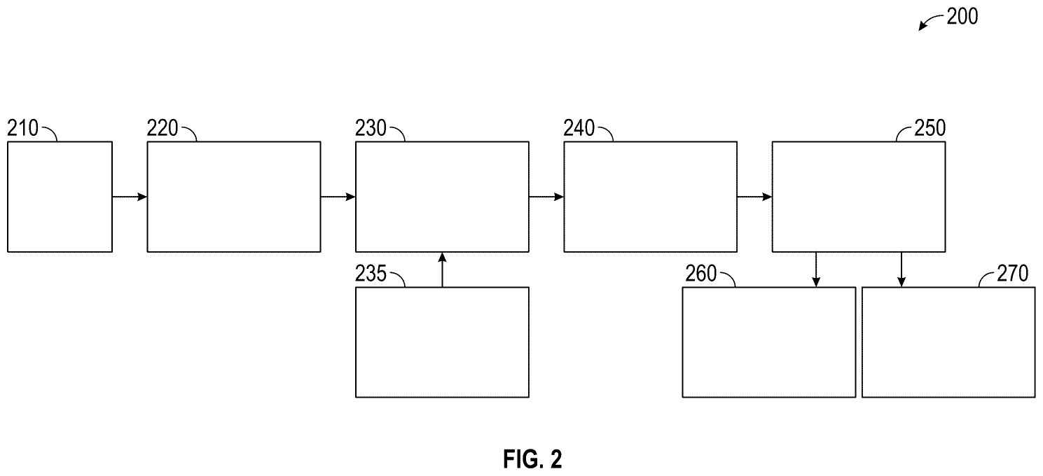

FIG. 2 is a process flow of a method 200 of making a vehicle camera-based prediction of a change in pedestrian motion according to one or more embodiments. At block 210, the processes include obtaining video from the camera 110. The video is obtained by the camera 110 as a plurality of frames (e.g., 30 frames per second) in the field of view of the camera 110. At block 220, implementing feature extraction using a neural network is performed for each frame of the video obtained at block 210. This feature extraction is known and is used for subsequent classification used to identify objects in each image frame, including the identification of objects that pertain to one or more pedestrians 140.

At block 230, the processes include extracting pedestrian features over multiple frames. The processes at block 230 require three-dimensional (3D) object detection performed at block 235. At block 235, 3D object detection may use a camera 110 or any of the other sensors 130 (e.g., lidar system, radar system). A known object detection neural network may be used with any one or more of the sensors 110, 130 to overlay a bounding box indicating pedestrians 140 on the image frames. Position and heading may also be obtained at block 235. At block 230, the bounding boxes indicating pedestrians 140 (from block 235) and the features that are extracted from each of the image frames (at block 210) are combined to extract the features associated with pedestrians 140 over multiple frames.

At block 240, the processes include performing pedestrian feature association over the frames of the video. That is, the features obtained from areas of each image frame associated with a pedestrian 140, at block 230, are grouped according to each pedestrian 140. This grouping may be done based on Euclidian distance between feature vectors from frame to frame, for example. Alternately, another known feature association technique may be used. As a result, at block 240, the features associated with the same pedestrian over the multiple frames are associated.

At block 250, a neural network is implemented to classify the motion of each pedestrian 140 from the features associated with each pedestrian 140 over a number of frames. That is, the neural network implemented at block 250 is trained to classify the motion of each pedestrian 140 identified in the video obtained at block 210. The position and heading (from bock 235) over the frames of the video may be used for the classification, for example. The neural network may be trained in a supervised training procedure that compares the neural network classification output with the known motion for pedestrians 140 in the videos used in the training.

Providing the classification of pedestrian motion, at block 260, may involve providing one of the exemplary classifications for pedestrian motion that are indicated in Table 1.

TABLE 1
Exemplary pedestrian motion classifications.
CLASSIFICATION

starting walking
stopping
turning left
turning right
transitioning to run from walking
transitioning to walk from running
transitioning to walk from standing
continue standing
continue walking

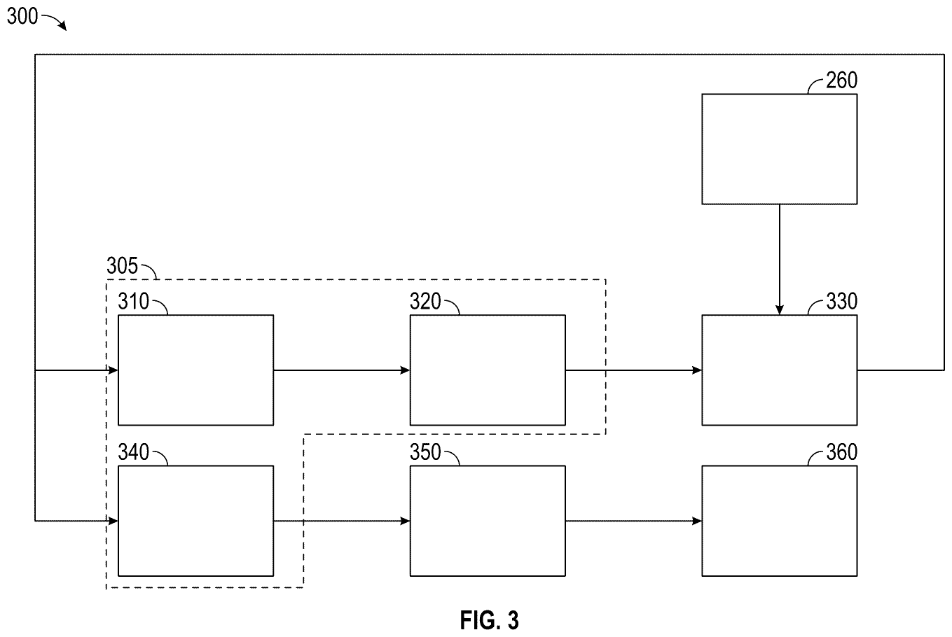

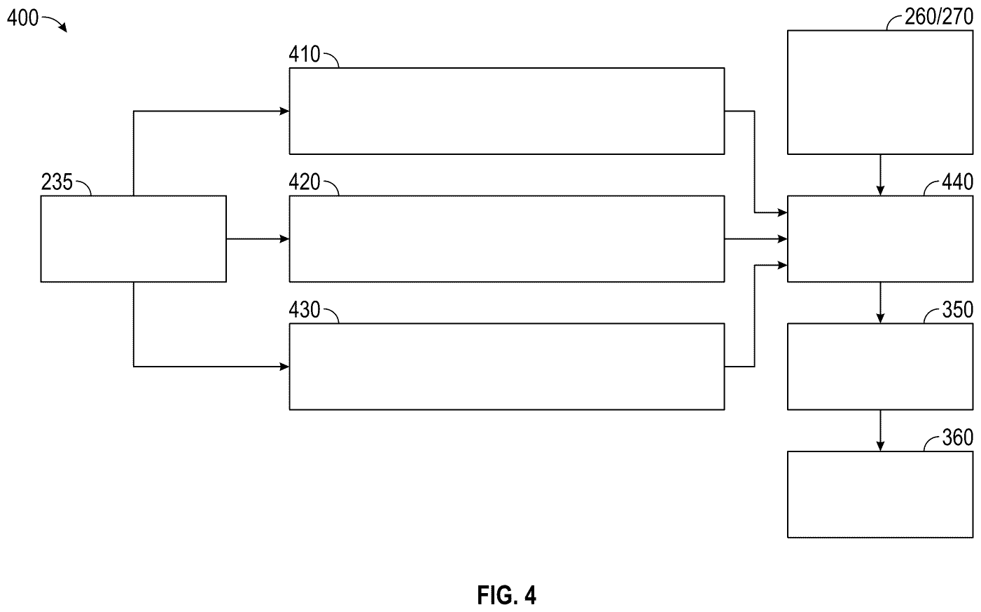

The exemplary classifications indicated in Table 1 are not intended to limit additional classifications that may be provided, at block 260, based on training of the neural network that is implemented at block 250. A classification may be provided (at block 260) for each of the pedestrians 140 detected in the video obtained at block 210. As discussed with reference to FIGS. 3 and 4, the classification provided at block 260 may be used to improve the trajectory prediction for each pedestrian 140 that may be used to control the vehicle 100. For example, if a classification is provided (at block 260) as “transitioning to walk from standing” for a pedestrian 140 who is about to cross in front of the vehicle 100, then automated braking or another operation may be performed (at block 360, FIGS. 3, 4) sooner than if the classification were “continue standing.”

At block 270, rather than a single classification (as provided at block 260), a probability may be provided for one or more classifications. For example, for a given pedestrian 140 who is standing at a curb, the classification may be provided as a 70 percent probability of “start walking” and 30 percent probability of “continue standing.”

FIGS. 3 and 4 are different exemplary embodiments of how the classification (provided at block 260) may improve vehicle behavior. That is, the classification of pedestrian movement provided at block 260 is used to improve trajectory prediction (at block 350) for each pedestrian 140 in the field of view of the camera 110. The improved trajectory prediction results in improved decision-making regarding one or more operations of the vehicle 100 (at block 360).

FIG. 3 is a process flow of a method 300 of using a vehicle camera-based prediction of a change in pedestrian motion to control the vehicle 100 according to an exemplary embodiment. The exemplary approach shown in FIG. 3 may be considered a binary approach because a single classification (e.g., change (e.g., start walking, turning right), no change) is provided at block 260 for each pedestrian 140 whose movement is tracked. That is, the processes shown in FIG. 3 are performed for each pedestrian 140 in the field of view of the camera 110, for example.

According to the exemplary embodiment shown in FIG. 3, implementation of a predictive algorithm (e.g., Kalman filter) for each pedestrian 140, at block 305, is enhanced with the classification of pedestrian motion provided at block 260. In particular, updating the state vector and covariance matrix, at block 330, which is used by the Kalman filter (at block 305), is enhanced by the classification of pedestrian motion provided at block 260. The state vector refers to a velocity vector. At time index n, the velocity vector is indicated as vₙ, a heading vector is indicated as bₙ, and a rotation matrix with rotation angle θ is indicated as R(θ). The covariance matrix at time index n (Cₙ) is an error matrix of the Kalman filter.

At block 330, updating the state vector for the next time index n+1 (i.e., velocity vector vₙ₊₁) is for a given pedestrian 140 and depends on the classification provided for that pedestrian 140 at block 260. Exemplary updated state vectors corresponding with different classifications of pedestrian motion are indicated in Table 2.

TABLE 2
Exemplary velocity vector updates corresponding
to pedestrian motion classifications.

| CLASSIFICATION | velocity vector νₙ₊₁ |
|---|---|
| starting walking | Δ₁ * bₙ (Δ₁ = average acceleration at |
| | start of walking) |
| stopping | νₙ − Δ₂ * bₙ (Δ₂ = average |
| | deceleration for stopping) |
| turning left | R(θₜ)νₙ (θₜ = average turn angle) |
| turning right | R(−θₜ)νₙ (θₜ = average turn angle) |

Without additional sources of error, the covariance matrix Cₙ₊₁ may be C₀.

The updated state vector and covariance matrix (from block 330) is provided for implementing the prediction algorithm (at block 305). In the exemplary case of the predictive algorithm being a Kalman filter, the algorithm includes providing a short-term prediction, at block 310, as well as providing a long-term prediction, at block 340. Both the short-term prediction and long-term prediction may be obtained as vₙ*T with T being a duration that is shorter for the short-term prediction and longer for the long-term prediction. The short-term prediction may be for a frame (e.g., duration T is on the order of 0.5 seconds) while the long-term prediction may be for a longer period (e.g., duration T on the order of 2 seconds). At block 320, the short-term prediction (from block 310) may be updated based on measurements (e.g., based on image processing from images obtained by the camera 110 and lidar system) of position and heading of each pedestrian 140. These updates (at block 320) are used to update the state vector and covariance matrix at block 330. As previously noted, the classification of pedestrian motion (from block 260) may enhance this updated state vector and covariance matrix that is used for the predictions (at blocks 310 and 340).

The long-term prediction (provided at block 340) may be used to provide a trajectory prediction for each pedestrian 140. For example, based on updating the state vector and covariance matrix (at block 330) with a classification of “start walking” (from block 260), the long-term prediction at block 340 may be used to provide a trajectory prediction, at block 350, that indicates where the pedestrian 140 will be walking in the future to (i.e., position, velocity, and heading). At block 360, controlling vehicle operation refers to using the trajectory prediction obtained at block 350 for each pedestrian 140 to perform auto braking, collision avoidance, path planning, or any number of semi-autonomous or autonomous actions.

FIG. 4 is a process flow of a method 400 of using a vehicle camera-based prediction of a change in pedestrian motion to control the vehicle 100 according to an exemplary embodiment. The exemplary embodiment shown in FIG. 4 may be a probability-based approach because the trajectory prediction (at block 350) for each pedestrian 140 may be enhanced by a classification probability provided at block 270. Alternately, a classification provided at block 260 may be used. As with the exemplary embodiment shown in FIG. 3, the processes shown in FIG. 4 may be implemented for each pedestrian 140 that is detected.

At block 235, position and heading are detected for a given pedestrian 140 using a camera 110 or other sensor 130, as previously noted. The position and heading determined at block 235 are used in three different ways at blocks 410, 420, and 430. At block 410, the processes include obtaining a prediction of the motion of the pedestrian 140 and updating the state vector (i.e., velocity vector vn+1) with a constant velocity motion model. That is, the velocity vector vₙ₊₁ is determined using noise wₙ as:

vₙ₊₁=vₙ+wₙ [EQ. 1]

The constant velocity motion model may be associated with a continuing pedestrian motion classification (e.g., continue walking, continue standing). At block 420, the processes include obtaining a prediction of the motion of the pedestrian 140 and updating the state vector (i.e., velocity vector vₙ₊₁) with a constant cartesian acceleration motion model. That is, the velocity vector vₙ₊₁ is determined as:

vₙ₊₁=vₙ+Δ*bₙ+wₙ [EQ. 2]

The constant cartesian acceleration motion model may be associated with an accelerating pedestrian motion classification (e.g., transitioning to run from walking).

At block 430, the processes include obtaining a prediction of the motion of the pedestrian 140 and updating the state vector (i.e., velocity vector vn+₁) with an angular acceleration motion model. That is, the velocity vector vₙ₊₁ is determined as:

nₙ₊₁=R(θ)vₙ+wₙ [EQ. 3]

The angular acceleration motion model may be associated with a turning pedestrian motion classification (e.g., turning right, turning left).

At block 440, selecting one of the updates of the state vector (from block 410, 420, or 430) or obtaining a weighted combination (from blocks 410, 420, and 430) is based on the classification or classification probability obtained from block 260 or 270. For example, if the classification provided at block 260 is “turning right,” then selecting an update of the state vector, at block 440, may be selection of the result from block 430. Alternately, obtaining a weighted combination may include weighting the result from block 430 the highest and the result from block 410 the lowest. The weighting may be obtained from the classifier implemented at block 250.

The classifier provides probabilities associated with each class (i.e., each pedestrian motion classification) and this probability is used as the weight (at block 270). The class with the highest probability is provided (at block 260) and is used to update the state vector and covariance matrix (at block 330) but the probabilities of the different classes (provided at block 270) may be applied as weights to the results of the associated models (at blocks 410, 420, 430) at block 440.

Based on the selected or obtained state vector (i.e., velocity vector vₙ₊₁) at block 440, providing a trajectory prediction for the pedestrian 140 (at block 350) and controlling vehicle operation (at block 360) may be performed as discussed with reference to FIG. 3.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system in a vehicle comprising:
a camera configured to obtain video in a field of view over a number of frames; and
a controller configured to process the video to identify one or more pedestrians, to implement a neural network to provide a classification of a motion of each pedestrian among a set of classifications of pedestrian motion, wherein each classification among the set of classifications indicates initiation of the motion or no change in the motion, to predict a trajectory for each pedestrian based on the classification of the motion, and to control operation of the vehicle based on the trajectory predicted for each pedestrian.

2. The system according to claim 1, wherein the controller identifying the one or more pedestrians includes the controller being configured to implement a second neural network to perform feature extraction on each of the frames of the video to identify features in each of the frames of the video.

3. The system according to claim 2, wherein the controller identifying the one or more pedestrians includes the controller being configured to use the features and identification of the one or more pedestrians based on other sensors to identify, as pedestrian features, the features in each of the frames of the video that pertain to the one or more pedestrians.

4. The system according to claim 3, wherein the controller identifying the one or more pedestrians includes the controller being configured to perform feature association on the pedestrian features in each of the frames of the video such that all the pedestrian features associated with each pedestrian among the one or more pedestrians are grouped separately.

5. The system according to claim 4, wherein the controller is configured to implement the neural network on the pedestrian features associated with each pedestrian to provide the classification of the motion of each pedestrian.

6. The system according to claim 5, wherein the controller is configured to predict the trajectory for each pedestrian using a predictive algorithm.

7. The system according to claim 6, wherein the predictive algorithm uses a Kalman filter and is configured to update a state vector and covariance matrix used by the Kalman filter based on the classification of the motion.

8. The system according to claim 6, wherein the predictive algorithm uses a position and heading for each pedestrian along with a constant velocity model, a constant cartesian acceleration motion model, and an angular acceleration motion model.

9. The system according to claim 8, wherein the controller is configured to select a result of the constant velocity motion model, the constant cartesian acceleration motion model, or the angular acceleration motion model for each pedestrian based on the classification of the motion for the pedestrian.

10. The system according to claim 8, wherein the controller is configured to provide two or more classifications of the motion for each pedestrian in conjunction with a probability for each of the two or more classifications of the motion, each of the constant velocity model, the constant cartesian acceleration motion model, and the angular acceleration motion model is associated with one or more of the set of classifications of pedestrian motion, and the controller is configured to weight a result of the constant velocity motion model, the constant cartesian acceleration motion model, and the angular acceleration motion model for each pedestrian based on the probability associated with each classification of the motion for the pedestrian.

11. A non-transitory computer-readable medium configured to store instructions that, when processed by one or more processors, cause the one or more processors to implement a method in a vehicle, the method comprising:
obtaining video from a camera field of view over a number of frames;
processing the video to identify one or more pedestrians;
implementing a neural network to provide a classification of a motion of each pedestrian among a set of classifications of pedestrian motion, wherein each classification among the set of classifications indicates initiation of the motion or no change in the motion;
predicting a trajectory for each pedestrian based on the classification of the motion; and
controlling operation of the vehicle based on the trajectory predicted for each pedestrian.

12. The non-transitory computer-readable medium according to claim 11, further comprising identifying the one or more pedestrians by implementing a second neural network to perform feature extraction on each of the frames of the video to identify features in each of the frames of the video.

13. The non-transitory computer-readable medium according to claim 12, wherein the identifying the one or more pedestrians includes using the features and identification of the one or more pedestrians based on other sensors to identify, as pedestrian features, the features in each of the frames of the video that pertain to the one or more pedestrians.

14. The non-transitory computer-readable medium according to claim 13, wherein the identifying the one or more pedestrians includes performing feature association on the pedestrian features in each of the frames of the video such that all the pedestrian features associated with each pedestrian among the one or more pedestrians are grouped separately.

15. The non-transitory computer-readable medium according to claim 14, wherein the implementing the neural network on the pedestrian features associated with each pedestrian is performed to provide the classification of the motion of each pedestrian.

16. The non-transitory computer-readable medium according to claim 15, wherein the predicting the trajectory for each pedestrian includes using a predictive algorithm.

17. The non-transitory computer-readable medium according to claim 16, wherein the using the predictive algorithm includes uses a Kalman filter and updating a state vector and covariance matrix used by the Kalman filter based on the classification of the motion.

18. The non-transitory computer-readable medium according to claim 16, wherein the using the predictive algorithm includes using a position and heading for each pedestrian along with a constant velocity model, a constant cartesian acceleration motion model, and an angular acceleration motion model.

19. The non-transitory computer-readable medium according to claim 18, further comprising selecting a result of the constant velocity motion model, the constant cartesian acceleration motion model, or the angular acceleration motion model for each pedestrian based on the classification of the motion for the pedestrian.

20. The non-transitory computer-readable medium according to claim 18, further comprising providing two or more classifications of the motion for each pedestrian in conjunction with a probability for each of the two or more classifications of the motion, wherein each of the constant velocity model, the constant cartesian acceleration motion model, and the angular acceleration motion model is associated with one or more of the set of classifications of pedestrian motion, and weighting a result of the constant velocity motion model, the constant cartesian acceleration motion model, and the angular acceleration motion model for each pedestrian based on the probability associated with each classification of the motion for the pedestrian.
